(19) United States
(12) Patent Application Publication
(10) Pub. No.: US 2013/0166775 A1
(43) Pub. Date: Jun. 27, 2013

(54) LOAD BALANCING APPARATUS AND LOAD BALANCING METHOD

(71) Applicants: Sunhee YANG, Daejeon (KR); Saehoon KANG, Daejeon (KR); Ji Soo SHIN, Daejeon (KR); Han Sol PARK, Daejeon (KR); Nam Kyoung UM, Chungcheongbuk-do (KR); Eunah KIM, Daejeon (KR)

(72) Inventors: Sunhee YANG, Daejeon (KR); Saehoon KANG, Daejeon (KR); Ji Soo SHIN, Daejeon (KR); Han Sol PARK, Daejeon (KR); Nam Kyoung UM, Chungcheongbuk-do (KR); Eunah KIM, Daejeon (KR)

(73) Assignee: Electronics and Telecommunications Research Institute, Daejoen (KR)

(21) Appl. No.: 13/620,072

(22) Filed: Sep. 14, 2012

(30) Foreign Application Priority Data
Dec. 26, 2011 (KR) 10-2011-0142453

(51) Int. Cl. G06F 15/173

(52) U.S. Cl. 709/241

(57) ABSTRACT

Provided are a load balancing apparatus, which is configured to prevent an overload from occurring and perform effectively a load balancing operation even for servers distributed throughout a network, and a load balancing method performed using the same. the method may include determining whether a data packet received from a client may be a packet requiring a load balancing operation, determining at least one of physical servers provided in a distributed server farm as an target server to provide a service to the client, depending on the judgment, determining a forwarding path between the client and the target server, determining a header rewriting node, and referring the forwarding path and the header rewriting node to determine a forwarding rule and load the forwarding rule on a switch provided on the forwarding path.

### CROSS-REFERENCE TO RELATED APPLICATIONS

This U.S. non-provisional patent application claims priority under 35 U.S.C. §119 to Korean Patent Application No. 10-2011-0142453, filed on Dec. 26, 2011, in the Korean Intellectual Property Office, the entire contents of which are hereby incorporated by reference.

### BACKGROUND OF THE INVENTION

Embodiments of the inventive concepts relate to a load balancing apparatus and a load balancing method, and in particular, to a load balancing apparatus performing a load balancing operation in an open-type path control network and a load balancing method performed using the same.

When a distributed server farm including a plurality of physical servers is connected to a client, a physical server to provide a service to a client may be determined in consideration of status or load level of the physical servers. This determination can be realized by a load balancing operation. The load balancing operation enables to replace expensive high performance servers with cheap servers. Accordingly, it is possible to reduce costs for installing and operating a server system.

Conventionally, a load balancing apparatus may be located directly in front of the distributed server farm. If a service request using virtual IP is received from a client, the load balancing apparatus determines a physical server for processing the requested service. The determination of the physical server may be performed based on a specific server scheduling algorithm. scheduling algorithm.

If the physical server is determined, the load balancing apparatus may perform a header rewriting operation, in which a destination address of a header of a data packet transmitted from the client is changed from virtual IP to real IP. Then, the load balancing apparatus may perform a packet switching operation. As a result, it is possible to prevent detailed information on the physical servers in the distributed server farm from being exposed to the outside as well as to improve security and user convenience of the system.

However, according to this method, since all operations should be performed by the load balancing apparatus, the load balancing apparatus may become overloaded. Furthermore, since the load balancing apparatus is provided directly in front of the distributed server farm, there is a difficulty in performing the load balancing operation for servers distributed throughout a network.

### SUMMARY

Embodiments of the inventive concepts provide a load balancing apparatus capable of preventing an overload from occurring and a load balancing method performed using the same.

Other example embodiments of the inventive concept provide a load balancing apparatus, in which a load balancing function is processed in a distributed manner by a plurality of components, and a load balancing method performed using the same.

Still other example embodiments of the inventive concept provide a load balancing apparatus capable of performing effectively a load balancing operation even for servers distributed throughout a network, and a load balancing method performed using the same.

According to example embodiments of the inventive concepts, a load balancing method may include determining whether a data packet received from a client may be a packet requiring a load balancing operation, determining at least one of physical servers provided in a distributed server farm as an target server to provide a service to the client, depending on the judgment, determining a forwarding path between the client and the target server, determining a header rewriting node, and referring the forwarding path and the header rewriting node to determine a forwarding rule and load the forwarding rule on a switch provided on the forwarding path.

In example embodiments, the method may further include adding and updating a management table, based on the forwarding rule.

In example embodiments, the management table may include a session table, a flow table, a client table, or a server table.

In example embodiments, the determining of the target server may include checking a session connected to the client, determining whether one of the physical servers connected to the session is in a available state, based on the checking of the session, and determining the physical server connected to the session as the target server, according to the judgment on the available state of the physical server connected to the session.

In example embodiments, the determining of the target server may further include finding a physical server with the least loaded among the physical servers, and the physical server with the least loaded may be determined as the target server.

In example embodiments, the determining and loading of the forwarding rule may include determining a first segment rule for a forwarding operation between the client and the header rewriting node, determining a second segment rule for a forwarding operation of the header rewriting node, determining a third segment rule for a forwarding operation between the header rewriting node and the target server, and selectively loading one of the first, second, and third segment rules on the switch, as a forwarding rule for the switch, according to a location of the switch.

In example embodiments, the method may further include adding the loaded forwarding rule in a flow table stored in the switch, based on the loaded forwarding rule.

In example embodiments, the method may further include forwarding the data packet provided from the client or the balancing unit to the target server, based on the flow table.

In example embodiments, the forwarding of the data packet may include querying the flow table to find a forwarding rule corresponding to the switch and the forwarding path, and forwarding the provided data packet to the target server, according to a result of the querying of the flow table to find the forwarding rule.

In example embodiments, the forwarding of the data packet may include determining whether the switch may be selected as the header rewriting node, and rewriting a header of the provided data packet, based on the judgment on the header rewriting node.

In example embodiments, the method may further include providing switch information on the provided data packet or the switch, according to a result of the querying of the flow table to find the forwarding rule.

According to example embodiments of the inventive concepts, a load balancing apparatus may include a balancing unit configured to determine at least one of physical servers provided in a distributed server farm as an target server for providing a service to a client and determine a forwarding path between the client and the target server and forwarding rules on the forwarding path, and a network unit including at least one switch located on the forwarding path and configured to forward a data packet transmitted from the client to the target server based on the forwarding rules.

In example embodiments, the at least one switch may include a switch located at a header rewriting node to rewrite a header of the data packet.

In example embodiments, the forwarding rules may include a first segment rule on a forwarding operation between the client and the header rewriting node, a second segment rule on a forwarding operation of the header rewriting node, and a third segment rule on a forwarding operation between the header rewriting node and the target server.

In example embodiments, the at least one switch may include a plurality of switches, each of which uses one of the first, second, and third segment rules as its own forwarding rule, based on a location thereof.

In example embodiments, each of the switches may be configured to forward the data packet to the target server, according to its own forwarding rule.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a block diagram illustrating a load balancing apparatus according to example embodiments of the inventive concept.

FIG. 2 is a block diagram of a balancing unit shown in FIG. 1.

FIG. 3 is a flow chart illustrating a load balancing method according to a first embodiment of the inventive concept.

FIG. 4 is a flow chart illustrating a load balancing method according to a second embodiment of the inventive concept.

FIG. 5 is a detailed flow chart of step S140 shown in FIG. 3.

FIG. 6 is a detailed flow chart of step S170 shown in FIG. 3.

FIGS. 7A and 7B are diagrams illustrating examples, to which a forwarding rule according to a load balancing method of the inventive concept is applied.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

A load balancing apparatus according to the inventive concept may be configured in such a way that a load balancing function is performed in a distributed processing manner, by a centralized controller and switches provided on a forwarding path, and this enables to prevent the load balancing apparatus from being overloaded. In addition, the load balancing apparatus according to the inventive concept may be configured to find a switch with the least loaded out of switches on the forwarding path and enable the found switch to rewrite a header of a data packet. Accordingly, it is possible to prevent the load balancing apparatus from being overloaded and deteriorated, and the load balancing can be effectively performed through servers distributed in a network system.

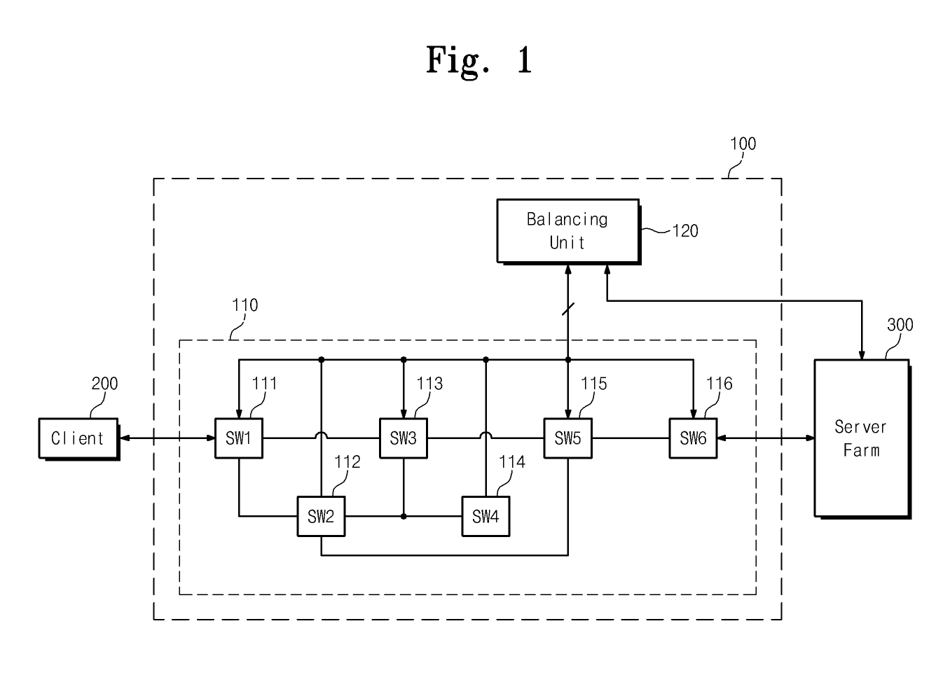

FIG. 1 is a block diagram illustrating a load balancing apparatus according to example embodiments of the inventive concept. Referring to FIG. 1, a load balancing apparatus 100 may include a balancing unit 120 and a network unit 110. The load balancing apparatus 100 may be configured in such a way that data communication can be performed between a client 200 and a distributed server farm 300 through the network unit 110.

In general, to increase resource efficiency of servers, the load balancing apparatus 100 may be configured to reduce a service response time to each client and prevent overload from occurring.

The network unit 110 may include a plurality of switches 111, 112, 113, 114, 115, and 116. For the sake of simplicity, the description that follows will refer to an example of the present embodiment in which the network unit 110 may include six switches, but example embodiments of the inventive concepts may not be limited thereto.

In some example embodiments, the network unit 110 may be an open-flow network, which may be one of open-type path control networks.

In the network unit 110, each of the switches 111, 112, 113, 114, 115, and 116 may be connected to at least one of the others. For example, each switch may be connected to one of the others or to two or more ones of the others.

Meanwhile, as will be described below, each switch may deliver a traffic flowed therein along a forwarding path, according to a forwarding rule corresponding to a given situation. The traffic flowed into each switch may include a data packet or a control message.

The network unit 110 may receive a data packet associated with a service request, from the client 200. The data packet may be firstly transmitted to the first switch 111 directly connected to the client 200. If the data packet transmitted to the first switch 111 is a first data packet for a service request, the first switch 111 may transfer the transmitted data packet to the balancing unit 120.

As will be described below, the data packet provided to the balancing unit 120 may be referred to determine a forwarding path and a forwarding rule. Here, the forwarding rule may mean a rule prescribing a packet processing method and a forwarding method, which may be performed by the switches located on the forwarding path of the data packet.

The balancing unit 120 may provide forwarding rules to the switches 111, 112, 113, 114, 115, and 116, respectively, according to a forwarding path and a node of each of the switches 111, 112, 113, 114, 115, and 116 of the network unit 110. The forwarding rules may be recorded in flow tables of the switches 111, 112, 113, 114, 115, and 116, respectively.

If the data packet transmitted to the first switch 111 is a second data packet for a service request, the first switch 111 may transfer the transmitted data packet to another switch connected thereto, according to its own forwarding rule.

Similarly, the switch, to which the data packet from the first switch 111 may be transferred, may transfer the transmitted data packet to other switch connected thereto, according to its own forwarding rule.

By repeating the above process, the data packet received from a client 200 may be transferred to the second switch 116 connected to the distributed server farm 300. Thereafter, the data packet may be transferred from the second switch 116 to the distributed server farm 300.

As will be described below, a virtual IP or a real IP of the distributed server farm 300 may be a destination of the data packet to be transferred to the distributed server farm 300. In the case where a virtual IP of the distributed server farm 300 is a destination of the data packet, the virtual IP of the data packet should be converted into its real IP to make a connection with a real physical server. This may be allowed by an operation of rewriting a header of the data packet.

In example embodiments, the header rewriting operation may be performed by one of the switches located on the forwarding path. In other words, the header rewriting operation may be a part of the load balancing operation, and thus, the load balancing function may be shared by at least one of the switches in the network unit 110. The sharing of the load balancing function may enable to prevent the balancing unit 120 from becoming overloaded.

Hereinafter, the switch, in which the header rewriting operation is performed, will be referred as to a “rewriting switch”, and a node provided with the rewriting switch will be referred as to a “header rewriting node”.

The balancing unit 120 may control the load balancing apparatus 100. The balancing unit 120 may decide a physical server (hereinafter, referred as to “target server”), which will be used to provide a service to the client 200, among the servers in the distributed server farm 300. The distributed server farm 300 may include a plurality of physical servers. For example, to decide the target server, the balancing unit 120 may refer to service-ready status of the physical servers in the distributed server farm 300. The service-ready status may be determined in consideration of an operation condition and a load level of the physical servers and indicate whether each of the physical servers can provide a requested service.

The balancing unit 120 may determine the forwarding path connecting the client 200 with the target server (not shown) and the forwarding rule controlling the switches located on the forwarding path. To determine the forwarding path and the forwarding rule, the balancing unit 120 may refer to the load level of each of the switches 111, 112, 113, 114, 115, and 116 in the network unit 110.

The balancing unit 120 may load the determined forwarding rule on the switches located on the determined forwarding path.

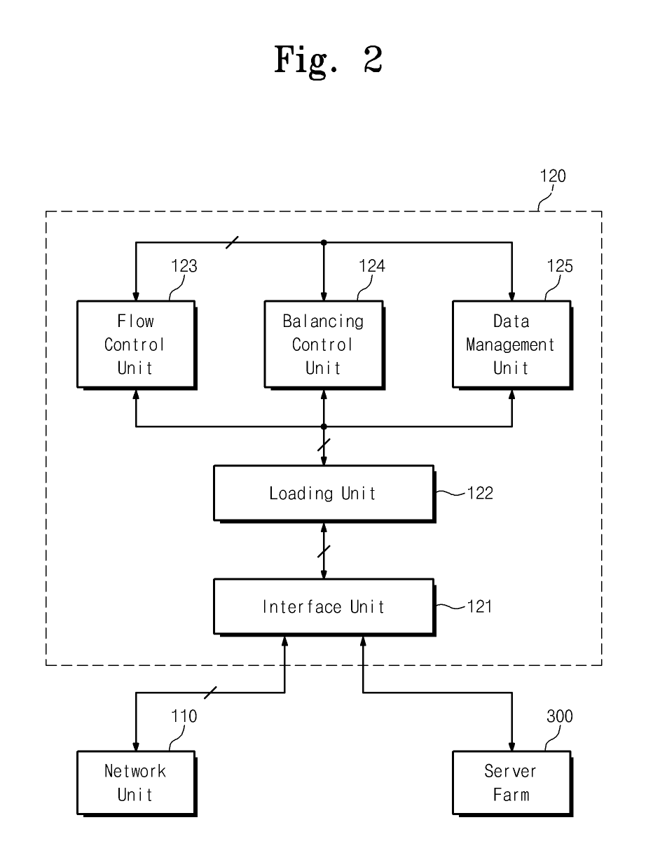

A configuration and an operation of the balancing unit 120 will be described in more detail with reference to FIG. 2.

According to the afore-described configuration, the network unit 110 may perform a part of the load balancing function. The balancing unit 120 may be configured to determine the forwarding rule corresponding to a given situation and load it on the switches 111, 112, 113, 114, 115, and 116. Accordingly, it is possible to prevent the balancing unit 120 from becoming overloaded. In addition, the balancing unit 120 can perform a proper load balancing operation on servers distributed throughout a network.

FIG. 2 is a block diagram of a balancing unit shown in FIG. 1. Referring to FIG. 2, the balancing unit 120 may include an interface part 121, a loading part 122, a flow control part 123, a balancing control part 124, and a data management part 125.

The interface part 121 may be configured to communicate data with the network unit 110 or the distributed server farm 300. In addition, the interface part 121 may classify the data received from the network unit 110 or the distributed server farm 300 and transmit the classified data to other components of the balancing unit 120.

In example embodiments, the data received by the interface part 121 may include location information and/or load information on the switches 111, 112, 113, 114, 115, and 116. Furthermore, the data received by the interface part 121 may include traffic information on the network unit 110. In addition, the data received by the interface part 121 may include status information and load information on each of physical servers (not shown) in the distributed server farm 300.

According to an example operation of the interface part 121, the data packet transmitted from the client 200 to the network unit 110 may be re-transmitted to the balancing unit 120. The data packet re-transmitted to the balancing unit 120 may be received and classified by the interface part 121, and then, transmitted to the flow control part 123, the balancing control part 124, or the data management part 125.

Similarly, the data packet provided from the distributed server farm 300 may be transmitted to the balancing unit 120 directly or via the network unit 110. In addition, the data packet transmitted to the balancing unit 120 may be received and classified by the interface part 121, and then, transmitted to the flow control part 123, the balancing control part 124, or the data management part 125.

So far, the description has referred to an example of the present embodiment in which the data from the interface part 121 may be transmitted to the flow control part 123, the balancing control part 124, or the data management part 125 via the loading part 122, but example embodiments of the inventive concepts may not be limited thereto. For example, in example embodiments, the data from the interface part 121 may be directly transmitted to the flow control part 123, the balancing control part 124, or the data management part 125. In other words, the data transmitting operation of the interface part 121 may be performed without the use of the loading part 122.

In some example embodiments, the interface part 121 may include a scheduler (not shown), which may discriminate a type of the received data and then transmit the data to one of the flow control part 123, the balancing control part 124, and the data management part 125 according to the type of the received data.

In some example embodiments, the scheduler (not shown) of the interface part 121 may classify the received data into three types: 1) a general data packet, 2) a data packet requiring the load balancing, or 3) a control message. The scheduler may be configured to transmit the general data packet, the data packet requiring the load balancing, the control message to the flow control part 123, the balancing control part 124, and the data management part 125, respectively.

The flow control part 123 may determine a forwarding path for the general data packet. The flow control part 123 may determine a forwarding rule of switches that may be located on a forwarding path for the general data packet.

The flow control part 123 may determine the forwarding path and the forwarding rule in consideration of topology information on the network unit 110 and the switches 111, 112, 113, 114, 115, and 116 or status information on the network unit 110 or the total system including the same. The topology and status information on the network unit 110 and/or the total system may be provided from the data management part 125. The forwarding path and the forwarding rule for the general data packet may be provided from determined to the loading part 122.

The balancing control part 124 may determine a forwarding path for the data packet requiring the load balancing. The data packet requiring the load balancing may be a part of the data packet, to which a part of the load balancing function (e.g., the header rewriting function) may performed. For example, the data packet requiring the load balancing may be a part of the data packet, which may be provided from the client 200 and have a virtual IP of the distributed server farm 300 as its destination.

The balancing control part 124 may determine a physical server (hereinafter, referred to as an “target server”) to process the data packet requiring the load balancing. The target server may be determined in consideration of an operation condition or a load level of physical servers (not shown) in the distributed server farm 300.

In addition, the balancing control part 124 may determine a forwarding path between the client 200 and the target server, through which the corresponding data packet will be transmitted. The balancing control part 124 may determine a forwarding rule of switches located on the forwarding path. The forwarding path and the forwarding rule may be determined in consideration of status information of physical servers in the distributed server farm 300, traffic or status information of the network 110, load levels of the switches 111, 112, 113, 114, 115, and 116, and so forth. Furthermore, the forwarding path and the forwarding rule may be determined in consideration of topology of the network unit 110 and the switches 111, 112, 113, 114, 115, and 116.

In example embodiments, the status information, the load information, and the topology information on the physical servers (not shown), the network unit 110 and the switches 111, 112, 113, 114, 115, and 116 may be provided from the data management part 125.

In example embodiments, the balancing control part 124 may determine which of the switches should be selected to perform the header rewriting operation. For example, the balancing control part 124 may be configured in such a way that the header rewriting operation will be performed by a switch, whose load level is smallest among the switches located on the forwarding path. The balancing control part 124 may provide the determined forwarding path and rule to the loading part 122.

This enables a part of the load balancing function to be shared by the switches located on the forwarding path. Accordingly, it is possible to prevent the balancing unit 120 from becoming overloaded.

The data management part 125 may store and manage information, which may be referred by the balancing unit 120 to determine forwarding paths and forwarding rules of data packets.

In some example embodiments, the data management part 125 may collect and manage status information and load information on the distributed server farm 300, the physical servers (not shown), the client 200, the network unit 110, and the switches 111, 112, 113, 114, 115, and 116.

In some example embodiments, the data management part 125 may collect and manage statistical information including status information on a forwarding (hereinafter, referred to as a “flow”) or session of the current data packet.

The loading part 122 may load the forwarding paths and the forwarding rules provided from the flow control part 123 and the balancing control part 124 on the switches 111, 112, 113, 114, 115, and 116 of the network unit 110. In example embodiments, the loading part 122 may provide a forwarding rule to each of the switches 111, 112, 113, 114, 115, and 116 in consideration of the forwarding path and locations of the switches 111, 112, 113, 114, 115, and 116.

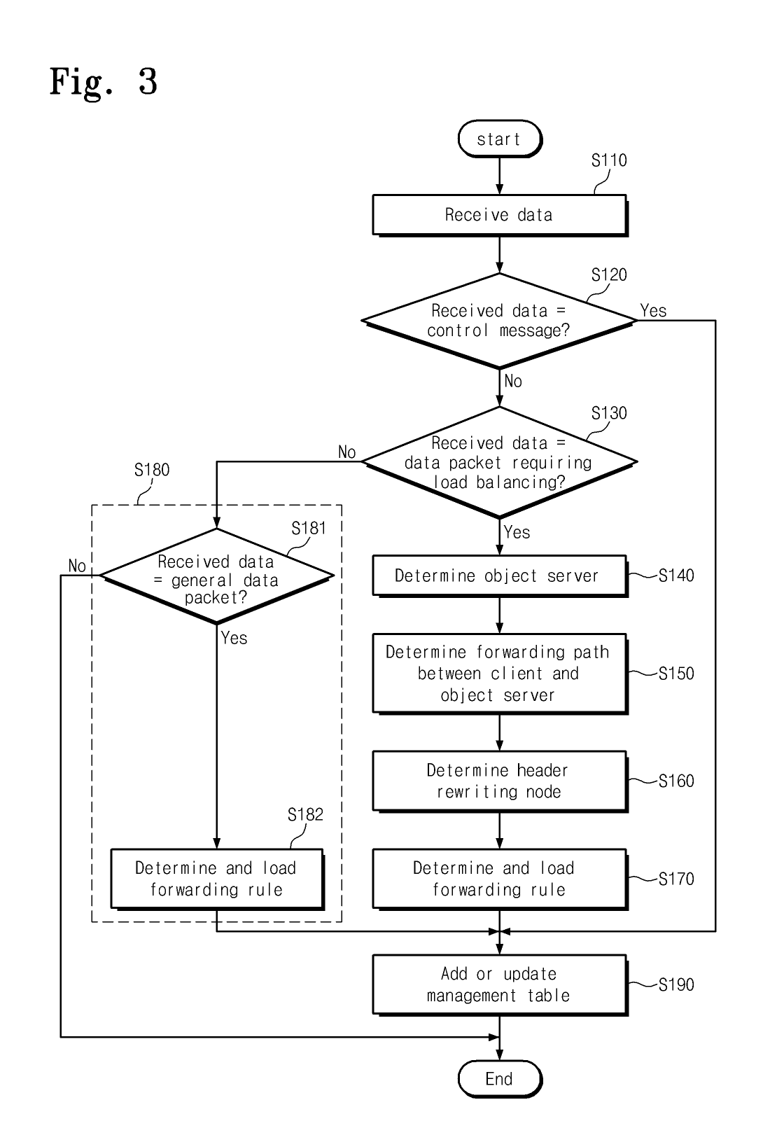

An operation of the balancing unit 120 will be described with reference to FIG. 3.

According to the afore-described configuration, the balancing unit 120 may determine a forwarding path and a forwarding rule on a data packet provided thereto and provide the forwarding path or the forwarding rule to the network unit 110. Each of the switches 111, 112, 113, 114, 115, and 116 in the network unit 110 may load a forwarding rule corresponding to a location and a forwarding path thereof.

FIG. 3 is a flow chart illustrating a load balancing method according to a first embodiment of the inventive concept. The load balancing method according to the first embodiment of the inventive concept may be performed using the balancing unit 120 and the interface part 121 previously described with reference to FIGS. 1 and 2. Referring to FIG. 3, a load balancing method according to the first embodiment of the inventive concept may include steps S110, S120, S130, S140, S150, S160, S170, S180, and S190.

In step S110, the balancing unit 120 may receive data from the network unit 110 or the distributed server farm 300. The data may include a general data packet, the data packet requiring the load balancing, or a control message.

In step S120, the balancing unit 120 may determine whether the data can be classified as the control message. The classification may be performed by the interface part 121 provided in the balancing unit 120.

If the data can be classified as the control message, the load balancing method proceeds to step S190. If not, the load balancing method proceeds to step S130.

In step S130, the balancing unit 120 may determine whether the data can be classified as the data packet requiring the load balancing. The classification may be performed by the interface part 121 provided in the balancing unit 120.

If the data can be classified as the data packet requiring the load balancing, the load balancing method proceeds to step S140. If not, the load balancing method proceeds to step S180.

In step S140, the balancing unit 120 may determine an target server, which may provide a service to the client 200, for the data packet requiring the load balancing. In some example embodiments, the determination of the target server may be performed by the balancing control part 124 provided in the balancing unit 120.

The target server may be selected from physical servers in the distributed server farm 300. To determine the target server, the balancing unit 120 may refer to whether there is a session currently connected to the client 200.

Furthermore, to determine the target server, the balancing unit 120 may refer to status information and load information on the distributed server farm 300 or the physical servers.

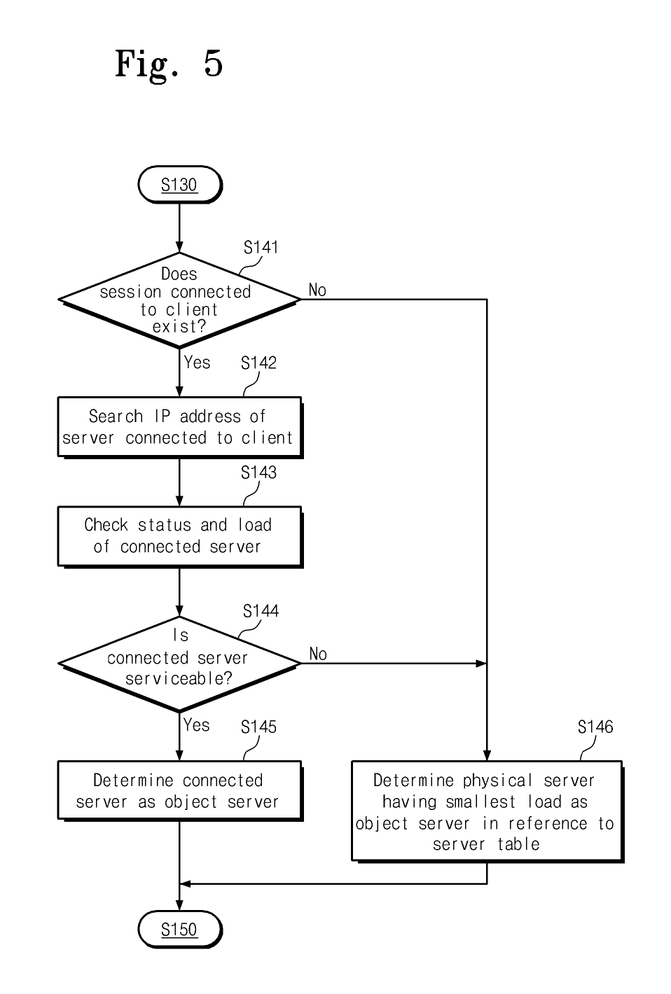

The operation of determining the target server using the balancing unit 120 will be described in more detail with reference to FIG. 5.

In step S150, the balancing unit 120 may determine a forwarding path, for the data packet requiring the load balancing. For example, the balancing unit 120 may determine a path between the client 200 and the target server, through which the data packet requiring the load balancing will be transmitted.

in some example embodiments, the determination of the forwarding path may be performed by the balancing control part 124 provided in the balancing unit 120. The forwarding path may be determined in consideration of status, load, and/or topology information on the network unit 110 and the switches 111, 112, 113, 114, 115, and 116. The forwarding path may be determined in consideration of status information on the client 200 or the target server.

In step S160, the balancing unit 120 may determine one of nodes provided on the forwarding path as a header rewriting node. Then, a switch located at the header rewriting node may serve as a header rewriting switch. The determination of the header rewriting node or the header rewriting switch may be performed by the balancing control part 124 provided in the balancing unit 120.

The header rewriting node or the header rewriting switch may be determined in consideration of load levels of switches provided on the forwarding path. In some example embodiments, the balancing unit 120 may determine a switch, whose load level is smallest among the switches provided on the forwarding path, as the header rewriting switch. A node provided with the header rewriting switch may serve as the header rewriting node. In the header rewriting node, a header rewriting operation may be performed to change a destination address (e.g., from virtual IP to real IP).

In some example embodiments, information associated with the load levels of the switches may be provided to the balancing unit 120, from the data management part 125.

In step S170, the balancing unit 120 may determine a forwarding rule in consideration of the forwarding path and locations of the switches 111, 112, 113, 114, 115, and 116. The forwarding rule may be configured to define a data packet processing method or a forwarding method for each switch.

The determination of the forwarding rule may be performed by the balancing control part 124 provided in the balancing unit 120.

The balancing unit 120 may provide the determined forwarding rule to the network unit 110. The provided forwarding rule may be loaded on each of the switches 111, 112, 113, 114, 115, and 116, according to the forwarding path and the locations of the switches 111, 112, 113, 114, 115, and 116.

In some example embodiments, the switches 111, 112, 113, 114, 115, and 116 may be provided with different forwarding rules from each other, according to the forwarding path and the locations of the switches 111, 112, 113, 114, 115, and 116. Thereafter, the load balancing method proceeds to step S190.

Referring back to step S130, if the data is not the data packet requiring the load balancing, the load balancing method proceeds to step S180.

In step S180, a forwarding path and a forwarding rule may be determined for a data packet not requiring the load balancing. Step S180 may include step S181 and step S182.

In step S181, the balancing unit 120 may determine whether the data packet can be classified as the general data packet. If the data packet is the general data packet, the load balancing method proceeds to step S182. If not, the load balancing method may be terminated.

In some example embodiments, the classification of the data packet may be performed by the interface part 121 provided in the balancing unit 120.

In step S182, the balancing unit 120 may determine an target server for the general data packet and determine a corresponding forwarding path and a corresponding forwarding rule. The target server, the forwarding path or the forwarding rule for the general data packet may be determined in consideration of status, load or topology information on the network unit 110 and the switches 111, 112, 113, 114, 115, and 116.

In some example embodiments, the target server, the forwarding path or the forwarding rule for the general data packet may be determined in consideration of status information on a source (or client) and a destination (or target server) of the data packet.

The determination of the target server, the forwarding path, and the forwarding rule may be performed by the flow control part 123 provided in the balancing unit 120.

The balancing unit 120 may provide the determined forwarding rule to the network unit 110. The provided forwarding rule may be loaded on each of the switches 111, 112, 113, 114, 115, and 116, according to the forwarding path and the locations of the switches 111, 112, 113, 114, 115, and 116.

In some example embodiments, the switches 111, 112, 113, 114, 115, and 116 may be provided with different forwarding rules from each other, according to the forwarding path and the locations of the switches 111, 112, 113, 114, 115, and 116.

In step S190, the balancing unit 120 may add a management table in the data management part 125 or update the management table. The adding or updating of the management table may be executed in consideration of the forwarding path or the forwarding rule associated with the general data packet or the data packet requiring the load balancing. Alternatively, the adding or updating of the management table may be executed in consideration of the received control message.

In some example embodiments, the management table may include a session table between the client 200 and the distributed server farm 300, a client table containing status information of the client 200, a server table containing status information or load information of the distributed server farm 300 and the physical servers, or a flow table containing information on transmitting paths for the data packet.

In some example embodiments, the management table may include a status table containing load information on the network unit 110 and the switches 111, 112, 113, 114, 115, and 116.

In some example embodiments, the updating of the management table may be performed to delete partially or wholly the flow table. The partial or whole deleting of the flow table may be performed in consideration of a flow termination message.

According to the first embodiment of the inventive concept, a forwarding path and a forwarding rule for a data packet may be determined. The determined forwarding rule may be provided to the network unit 110. A management table of the data management part 125 may be added or updated in consideration of the forwarding path, the forwarding rule, the control message, or status information on the system.

According to the configuration and operation of the balancing unit 120, the balancing unit 120 may not be provided directly in front of the distributed server farm 300. Accordingly, the balancing unit 120 can perform the load balancing operation on servers distributed in a network.

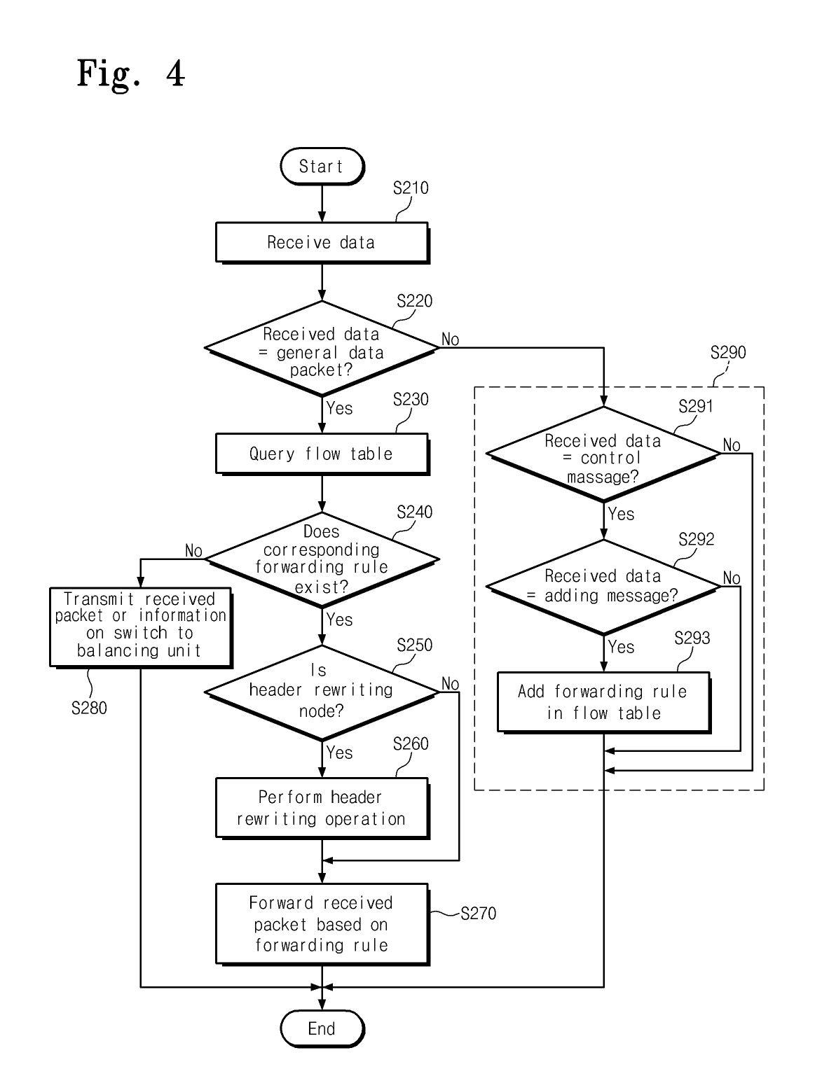

FIG. 4 is a flow chart illustrating a load balancing method according to a second embodiment of the inventive concept. The load balancing method according to the second embodiment of the inventive concept may be performed using the balancing unit 120 and the interface part 121 previously described with reference to FIGS. 1 and 2. Referring to FIG. 4, a load balancing method according to a second embodiment of the inventive concept may include steps S210, S220, S230, S240, S250, S260, S270, S280, and S290.

In the second embodiment of the inventive concept, each of the switches 111, 112, 113, 114, 115, and 116 may have the same configuration and the same operation algorithm as each other. Thus, for the sake of simplicity, an operation algorithm of the switch 111 will be exemplarily described below.

In step S210, the switch 111 may receive data from the client 200 or the balancing unit 120.

In step S220, the switch 111 may determine whether the data can be classified as a data packet. If the data is the data packet, the load balancing method proceeds to step S230. If not, the load balancing method proceeds to step S290.

In step S230, the switch 111 may query a flow table stored in the switch 111. The flow table stored in the switch 111 may store a data flow or a forwarding rule for the switch 111.

In some example embodiments, the querying of the flow table may be performed in consideration of address or port information on the client 200 or the target server, which may be described in the header of the data packet.

In step S240, the switch 111 may determine whether there is a forwarding rule corresponding to the received data packet in the flow table.

In some example embodiments, the presence of the corresponding forwarding rule can be determined by checking whether there is a data flow corresponding to the received data packet. In other words, if there is the corresponding data flow, there is the corresponding forwarding rule.

If there is the corresponding forwarding rule, the load balancing method proceeds to step S250. If not, the load balancing method proceeds to step S280.

In step S250, the switch 111 may refer to the forwarding rule to determine whether its node is the re-writing node or the switch 111 is the header rewriting switch. If a node provided with the switch 111 is the header rewriting node, the load balancing method proceeds to step S260. If not, the load balancing method proceeds to step S270.

In step S260, the switch 111 may perform the header rewriting operation. For example, the switch 111 may change a destination address (e.g., from virtual IP to real IP) in the header of the received data packet. Accordingly, the header rewriting operation, a part of the load balancing operation, can be performed by the switch 111, and it is possible to prevent the balancing unit 120 from becoming overloaded.

In step S270, the switch 111 may forward the received data packet to the target server, according to its own forwarding rule. The forwarding of the data packet may be relayed by other switch(s).

Referring back to step S240, if there is no corresponding forwarding rule, the load balancing method proceeds to step S280.

In step S280, since there is no corresponding forwarding rule, the received data packet may be transferred to the balancing unit 120 by the switch 111. In some example embodiments, the switch 111 may transfer not only the received data packet but also load information on the switch 111 to the balancing unit 120. The balancing unit 120 may determine a forwarding path or a forwarding rule for the received data packet, in consideration of the received data packet or load information on the switch 111.

Referring back to step S220, if the received data is not the data packet, the load balancing method proceeds to step S290. In step S290, the forwarding rule of the switch 111 may be added in the flow table of the switch 111. In example embodiments, step S290 may include steps S291, S292, and S293.

In step S291, the switch 111 may determine whether the received data can be classified as the control message. If the received data can be classified as the control message, the load balancing method proceeds to step S291. If not, the load balancing method may be terminated.

In step S292, the switch 111 may determine whether the received data can be classified as a forwarding rule adding message. If the received data is the forwarding rule adding message, the load balancing method proceeds to step S293. If not, the load balancing method may be terminated.

In step S293, the switch 111 may refer to the forwarding rule adding message to store a forwarding rule for the switch 111 in the flow table of the switch 111. In some example embodiments, the forwarding rule adding message may include the forwarding rule for the switch 111.

According to the second embodiment of the inventive concept, the switch 111 may transfer the data packet provided therein, based on its own forwarding rule. The switch 111 may store a forwarding rule provided from the balancing unit 120 in its own flow table.

In addition, the switch 111 may refer to its own forwarding rule to perform a re-writing operation on the header of the received data packet, which is a part of the load balancing operation. As the result of the header rewriting operation by the switch 111, a destination address contained in the header of the data packet may be changed from virtual IP to real IP. This prevents the balancing unit 120 from becoming overloaded.

FIG. 5 is a detailed flow chart of step S140 shown in FIG. 3. In step S140, the balancing control part 124 may determine a server to be used as the target server. Referring to FIG. 5, step S140 may include steps S141, S142, S143, S144, S145, and S146.

In step S141, the balancing control part 124 may determine whether there is a session connected between the client 200 and the distributed server farm 300. To do this, the balancing control part 124 may refer to a management table stored in the data management part 125. In some example embodiments, the management table may be a session table.

If there is the connected session, the load balancing method proceeds to step S142. Otherwise, the load balancing method proceeds to step S146.

In step S142, to support a persistent connection, the balancing control part 124 may select a physical server connected to the client 200 via a session as a provisional target server. In some example embodiments, the balancing control part 124 may search IP addresses of physical servers connected to the session, in order to select the provisional target server.

In step S143, the balancing control part 124 may check status information and load information on the provisional target server.

In step S144, the balancing control part 124 may refer to status information and load information on the provisional target server to determine whether the provisional target server is in a available state. If the provisional target server is in a state capable of providing a service to the client 200, the load balancing method proceeds to step S145. If not, the load balancing method proceeds to step S146.

In step S145, the provisional target server may be selected as the target server by the balancing control part 124.

In step S146, the balancing control part 124 may refer to the management table stored in the data management part 125 to perform the selection of the target server.

In some example embodiments, the balancing control part 124 may select a physical server, whose load is smallest among available physical servers in the distributed server farm 300, as the target server, to distribute load properly.

In some example embodiments, the management table, which may be referred by the balancing control part 124 in step S146, may be a server table. The server table may contain status information or load information on the physical servers in the distributed server farm 300.

According to the afore-described embodiment, the balancing control part 124 may select a physical server which is connected to the client 200 or whose load is smallest among the physical servers, as the target server.

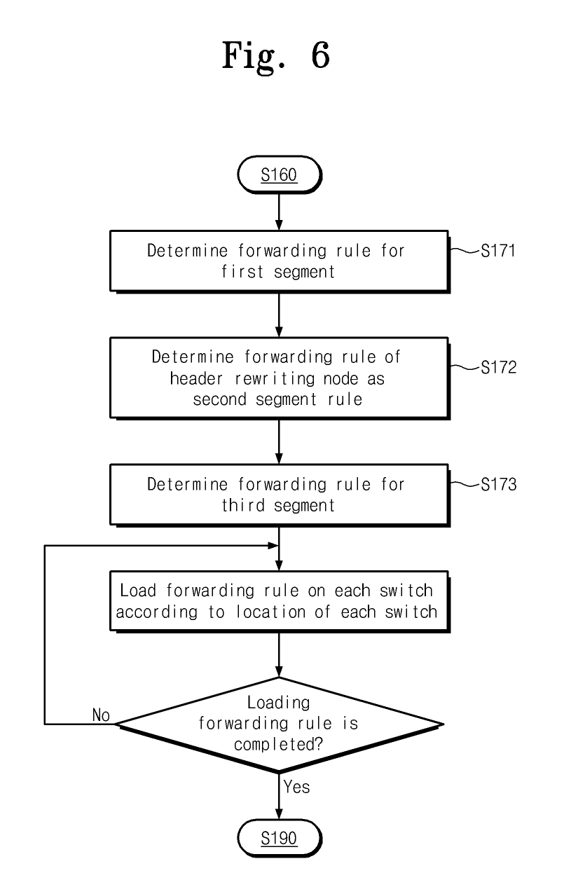

FIG. 6 is a detailed flow chart of step S170 shown in FIG. 3. In step S170, the balancing control part 124 may determine the forwarding rule, and the loading part 122 may load the determined forwarding rule on the switches 111, 112, 113, 114, 115, and 116, selectively. Referring to FIG. 6, step S170 may include steps S171, S172, S173, S174, and S175.

The forwarding path may divided into a portion from the client 200 just before the header rewriting node, which will be referred to as a “first segment”, the header rewriting node, which will be referred to as a “second segment”, and a portion from the header rewriting node to the target server, which will be referred to as a “third segment”.

In step S171, the balancing control part 124 may refer to the forwarding path or the header rewriting node determined in step S160 of FIG. 3 to determine a forwarding rule for the first segment (hereinafter, referred as to a “first segment rule”).

In step S172, the balancing control part 124 may refer to the header rewriting node to determine a forwarding rule for the second segment (hereinafter, referred as to a “second segment rule”).

In step S173, the balancing control part 124 may refer to the forwarding path or the header rewriting node to determine a forwarding rule for the third segment (hereinafter, referred as to a “third segment rule”).

In step S174, the balancing control part 124 may provide the forwarding path, the first segment rule, the second segment rule, or the third segment rule to the loading part 122.

The loading part 122 may refer to the forwarding path and locations of the switches 111, 112, 113, 114, 115, and 116 to load the corresponding forwarding rule selectively on each of the switches 111, 112, 113, 114, 115, and 116. In example embodiments, the forwarding rule to be loaded may contain one of the first segment rule, the second segment rule, or the third segment rule.

In step S175, the loading part 122 may determine whether the loading of the forwarding rule has been completed. If the loading of the forwarding rule has been completed, the load balancing method proceeds to step S190 of FIG. 3. If not, the load balancing method proceeds to step S174 to complete the loading of the forwarding rule.

According to the afore-described embodiment of the inventive concept, the forwarding path and a location of the header rewriting node may be referred to determine the forwarding rule for the switches provided on the forwarding path. The determined forwarding rule may be loaded on the switches provided on the forwarding path.

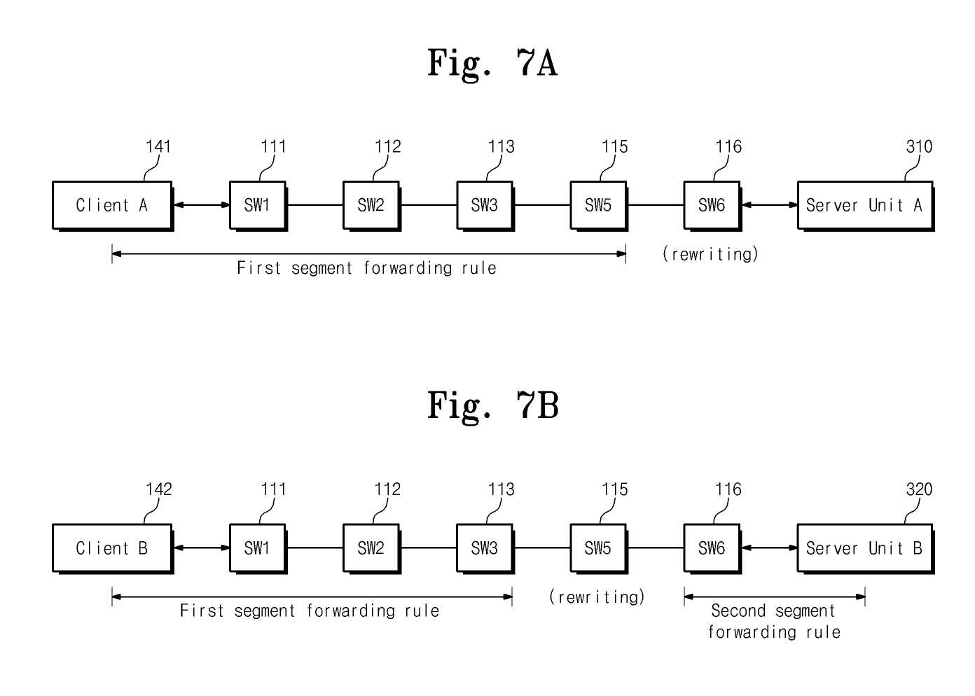

FIGS. 7A and 7B are diagrams illustrating examples, to which a forwarding rule according to a load balancing method of the inventive concept is applied. Each of clients 210 and 220 of FIGS. 7A and 7B may be configured to have the same technical feature as the client 200 described with reference to FIG. 1. Each of servers 310 and 320 of FIGS. 7A and 7B may be configured to have the same technical feature as the target server previously described.

Referring to FIG. 7A, the first switch 111, the second switch 112, the third switch 113, the fourth switch 115, and the fifth switch 116, which were described with reference to FIG. 1, may be sequentially provided on a forwarding path connecting the client A 210 with the server A 310.

Suppose that the fifth switch 116 is selected as the header rewriting switch. In this case, the selection of the header rewriting switch may be performed by the method described above. According to the method previously described with reference to FIG. 6, the first segment rule (or the first segment forwarding rule) may be applied to the first, the second, the third, and the fourth switches 111, 112, 113, and 115, which are provided between the client A 210 and the header rewriting node. The second segment rule (or the second segment forwarding rule) may be applied to the fifth switch 116.

Accordingly, each of the switches 111, 112, 113, 115, and 116 may process a data packet, based on the corresponding forwarding rule provided thereto.

Similarly, referring to FIG. 7B, the first switch 111, the second switch 112, the third switch 113, the fourth switch 115, and the fifth switch 116, which were described with reference to FIG. 1, may be sequentially provided on a forwarding path connecting the client B 220 and the server B 320.

Suppose that the fourth switch 115 is selected as the header rewriting switch. In this case, the selection of the header rewriting switch may be performed by the method described above. According to the method previously described with reference to FIG. 6, the first segment rule (or the first segment forwarding rule) may be applied to the first, the second, and the third switches 111, 112, and 113, which are provided between the client B 220 and the header rewriting node. The second segment rule (or the second segment forwarding rule) may be applied to the fourth switch 115. The third segment rule (or the third segment forwarding rule) may be applied to the fifth switch 116, which is provided between the header rewriting node and the server B 320.

Accordingly, each of the switches 111, 112, 113, 115, and 116 may process a data packet, based on the corresponding forwarding rule provided thereto.

According to the afore-described load balancing method, the balancing unit 120 may determine the forwarding path and the forwarding rule, and the determined forwarding rule may be selectively loaded on the switches 111, 112, 113, 114, 115, and 116 in the network unit 110. In addition, the header rewriting operation, a part of the load balancing operation, may be performed by one of the switches 111, 112, 113, 114, 115, and 116 provided on the forwarding path. Accordingly, it is possible to prevent the balancing unit 120 from becoming overloaded.

According to the afore-described load balancing method, the balancing unit 120 may not be disposed right in front of the distributed server farm 300. Accordingly, the load balancing operation can be effectively performed on servers distributed throughout a network.

According to example embodiments of the inventive concept, it is possible to prevent a load balancing apparatus from becoming overloaded.

It is possible to provide a load balancing apparatus, in which a load balancing function is processed in a distributed manner by a plurality of components, and a load balancing method realized using the load balancing apparatus.

Furthermore, it is possible to perform effectively a load balancing operation, even in the case that servers are distributed throughout a network.

While example embodiments of the inventive concepts have been particularly shown and described, it will be understood by one of ordinary skill in the art that variations in form and detail may be made therein without departing from the spirit and scope of the attached claims.

What is claimed is:

1. A load balancing method, comprising:
determining whether a data packet received from a client is requiring a load balancing operation;
determining at least one of physical servers provided in distributed server farm as a target server to provide service to the client, depending on the judgment;
determining a forwarding path between the client and the target server;
determining a header rewriting node on the forwarding path; and
referring the forwarding path and the header rewriting node to determine a forwarding rule and load the forwarding rule on switches located on the forwarding path.

2. The method of claim 1, further comprising, adding and updating a management table, based on the forwarding rule.

3. The method of claim 2, wherein the management table comprises a session table, a flow table, a client table, or a server table.

4. The method of claim 1, wherein the determining of the target server comprises:
checking a session connected to the client;
determining whether one of the physical servers connected to the session is in an available state, based on the checking of the session; and
determining the physical server connected to the session as the target server, according to the determination on the available state of the physical server connected to the session.

5. The method of claim 4, wherein the determining of the target server further comprises finding a physical server with the least loaded among the physical servers, and the physical server with the least loaded is determined as the target server.

6. The method of claim 1, wherein the determining and loading of the forwarding rule comprises:
determining a first segment rule for a forwarding operation between the client and the header rewriting node;
determining a second segment rule for a forwarding operation of the header rewriting node;
determining a third segment rule for a forwarding operation between the header rewriting node and the target server; and
selectively loading one of the first, second, and third segment rules on the switch, as a forwarding rule for the switch, according to a location of the switch.

7. The method of claim 1, wherein the determining a header rewriting node comprises:
determining a node including a switch with the least loaded, which is among the switches located on the forwarding path, as the header rewriting node.

8. A load balancing apparatus, comprising:
a balancing unit configured to determine at least one of physical servers provided in distributed server farm as a target server for providing a service to a client and determine a forwarding path between the client and the target server and forwarding rules on the forwarding path; and
a network unit including at least one switch located on the forwarding path and configured to forward a data packet transmitted from the client to the target server based on the forwarding rules.

9. The apparatus of claim 12, wherein the at least one switch comprises a switch located on a header rewriting node to rewrite a header of the data packet.

10. The apparatus of claim 13, wherein the forwarding rules comprises a first segment rule on a forwarding operation between the client and the header rewriting node, a second segment rule on a forwarding operation of the header rewriting node, and a third segment rule on a forwarding operation between the header rewriting node and the target server.

11. The apparatus of claim 14, wherein the at least one switch comprises a plurality of switches, each of which uses one of the first, second, and third segment rules as its own forwarding rule, based on a location thereof.

12. The apparatus of claim 15, wherein each of the switches is configured to forward the data packet to the target server, according to its own forwarding rule.
